(19) United States
(12) Patent Application Publication
(10) Pub. No.: US 2016/0275114 A1
(43) Pub. Date: Sep. 22, 2016

(54) COLUMN-STORE DATABASE MANAGEMENT SYSTEM

(71) Applicant: NEC Corporation, Tokyo (JP)

(72) Inventor: Toshiyuki ASARI, Tokyo (JP)

(73) Assignee: NEC Corporation

(21) Appl. No.: 15/045,733

(22) Filed: Feb. 17, 2016

(30) Foreign Application Priority Data
Mar. 17, 2015 (JP) 2015-053201

(51) Int. Cl. G06F 17/30

(52) U.S. Cl. CPC G06F 17/30312; G06F 17/30289

(57) ABSTRACT

A column-store database management system includes a storage unit that stores a predetermined data structure, and a database management unit. The data structure corresponds to table-format data expressed as arrays of records including field values of each field, and includes, for each field, a value list in which field values in the field are stored corresponding to field value numbers uniquely specifying the field values, and a value number array including information designating the field values in the record order. The storage unit stores a first data structure that corresponds to first table-format data and includes a value list and a value number array of the first field. When the database management unit generates a second data structure from the second table-format data, it generates a value list of the first field of the second data structure using the value list of the first field of the first data structure.

### INCORPORATION BY REFERENCE

The present invention is based upon and claims the benefit of priority from Japanese patent application No. 2015-053201, filed on Mar. 17, 2015, the disclosure of which is incorporated herein in its entirety by reference.

### TECHNICAL FIELD

The present invention relates to a column-store database management system, a data loading method, and a program.

### BACKGROUND ART

Relational database management system (RDBMS) is a database system of a type in which information is stored as a table which is a set of records consisting of some fields. A field, a record, and a table are also named as a column, a row, and a table, respectively. Relational database management systems include a typical row-oriented relational database management system, and a column-oriented relational database management system which is called a column-store database management system. The former relational database management system, which is a typical one, handles data as a whole in a row direction. As such, it is suitable for online transaction involving addition, update, and deletion. On the other hand, as the latter column-store database management system handles data in a column direction, it is suitable for tabulation processing and searching in which a column is extracted to be operated. The present invention is directed to an improvement of the latter column-store database management system.

The column-store database management system, in which data is handled as a whole in a column direction, adopts a data structure which holds data while eliminating duplicate data for each column. For example, the data structure called a FAST structure includes, for each field of table-format data, a value list in which field values in the field are stored corresponding to field value numbers uniquely specifying the field values, and a value number array in which information designating the field value numbers in the record order is stored (for example, see JP 3581831 B (Patent Document 1)).

FIG. 19 shows an example of table-format data and FAST structure data corresponding thereto. The table-format data in this example is expressed as arrays of records (rows) including field values relating to the respective fields (respective columns) such as student ID number, name, date of birth, and sex. Further, the FAST structure data consists of an order set showing row numbers, and a pair of a value list and a value number array of each column. In the value list of a field, field values in the field are stored, corresponding to field value numbers uniquely specifying the field values existing in the field. For example, in the value list according to the sex field, field values of male and female are stored corresponding to the field value numbers of 0 and 1. Further, in the value number array according to a field, information designating field value numbers in the record order is stored. For example, in the value number array according to the sex field, information designating the field values of 1, 0, 0, 0, 1, 1, 0, 0, 1, 0 in the record order is stored.

Patent Document 1: JP 3581831 B

In the column-store database management system using a FAST structure, when new table-format data is loaded to a storage unit, the table-format data must be converted to have a FAST structure. In order to convert the table-format data to have a FAST structure, it is necessary to generate a value list and a value number array for each field of the table-format data. A value list can be generated by sorting all field values according to a field by eliminating duplication with use of a typical sorting method such as merge sort. Further, a value number array can be generated by matching the respective field value in the field with the value list of the field. However, while the order O of calculation amount required for generating the value number array is n, the order O of calculation amount required for generating the value list is n×log n. Here, n represents the number of rows of the table-format data. As such, the order of calculation amount required for converting the table-format data to have a FAST structure is n×Log n. As such, regarding table-format data having a large number of rows n, a long time is required for generating a value list for each field. Consequently, there is a problem that it is difficult to load new table-format data at a high speed.

### SUMMARY

An exemplary object of the present invention is to provide a column-store database management system which solves the above-described problem that is, a problem that it is difficult to load new table-format data at a high speed.

A column-store database management system, according to an exemplary embodiment of the present invention, is a column-store database management system including a storage unit and a database management unit connected with the storage unit. The storage unit stores a data structure corresponding to table-format data expressed as arrays of records including field values relating to each field. The data structure includes, for each field, a value list in which field values in the field are stored corresponding to field value numbers uniquely specifying the field values, and a value number array in which information designating the field value number in a record order is stored. The storage unit stores a first data structure that corresponds to first table-format data and includes the value list and the value number array according to a first field. The database management unit includes a data structure generation unit that generates a second data structure for storing in the storage unit from second table-format data input. The data structure generation unit generates the value list according to the first field of the second data structure with use of the value list according to the first field of the first data structure.

A data loading method according to another exemplary embodiment of the present invention is a data loading method in a column-store database management system including a storage unit and a database management unit connected with the storage unit. The storage unit stores a data structure corresponding to table-format data expressed as arrays of records including field values relating to each field. The data structure includes, for each field, a value list in which field values in the field are stored corresponding to field value numbers uniquely specifying the field values, and a value number array in which information designating the field value numbers in a record order is stored. The method includes, by the storage unit, storing a first data structure that corresponds to first table-format data and includes the value list and the value number array according to a first field; and by the database management unit, generating a second data structure for storing in the storage unit from second table-format data input. When generating the second data structure, the database management unit generates the value list according to the first field of the second data structure with use of the value list according to the first field of the first data structure.

A non-transitory computer readable medium storing a program, according another exemplary embodiment of the present invention, causes a computer to function as, the computer constituting a database management unit in a column-store data management system, the column-store data management system including a storage unit and the database management unit connected with the storage unit, the storage unit storing a data structure corresponding to table-format data expressed as arrays of records including field values relating to each field, the data structure including, for each field, a value list and a value number array, the value list being configured such that field values in the field are stored corresponding to field value numbers uniquely specifying the field values, the value number array being configured such that information designating the field value numbers in a record order is stored, the storage unit storing a first data structure corresponding to the first table-format data and including the value list and the value number array according to a first field:

a data structure generation unit that generates a second data structure for storing in the storage unit from second table-format data input, and when generating, generates the value list according to the first field of the second data structure with use of the value list according to the first field of the first data structure.

As the present invention has the configuration described above, it is possible to realize high-speed loading of table-format data.

### BRIEF DESCRIPTION OF THE DRAWINGS

FIG. 1 is a block diagram of a column-store database management system according to a first exemplary embodiment of the present invention;

FIG. 2 shows a procedure of generating a VL and a VNo of a column of a second data group using a VL of a column of a first data group, in the column-store database management system according to a second exemplary embodiment of the present invention;

FIG. 3 is a block diagram of a database management system according to the second exemplary embodiment of the present invention;

FIG. 4 shows an exemplary query for generating a table of time-series data to be partitioned, according to the second exemplary embodiment of the present invention;

FIG. 5 shows an exemplary content of an inheritance column defining unit in the second exemplary embodiment of the present invention;

FIG. 6 shows an exemplary content of a CSV file to be input, in the second exemplary embodiment of the present invention;

FIG. 7 is a flowchart showing a loading procedure in the second exemplary embodiment of the present invention;

FIG. 8 shows a specific example of a procedure of extracting new data by sequentially checking data in the second data group one by one and matching it with data in a VL in the first data group, in the second exemplary embodiment of the present invention;

FIG. 9 shows a specific example of a procedure of generating a VNo of the second data group in the second exemplary embodiment of the present invention;

FIG. 10 is a block diagram of a database management system according to a third exemplary embodiment of the present invention;

FIG. 11 shows an exemplary content of an inheritance column history information unit in the third exemplary embodiment of the present invention;

FIG. 12 shows an exemplary query in which a threshold is set for each inheritance column, and an example of an inheritance column definition generated based on the query, in the third exemplary embodiment of the present invention;

FIG. 13 is a block diagram of a database management system according to a fourth exemplary embodiment of the present invention;

FIG. 14 shows an exemplary content of a VL concordance rate information unit in the fourth exemplary embodiment of the present invention;

FIG. 15 shows an exemplary content of an inheritance column defining unit in the fourth exemplary embodiment of the present invention;

FIG. 16 is a block diagram of a database management system according to a fifth exemplary embodiment of the present invention;

FIG. 17 shows an exemplary definition of a sales table in the fifth exemplary embodiment of the present invention;

FIG. 18 shows an exemplary content of a master column defining unit according to the fifth exemplary embodiment of the present invention;

FIG. 19 shows examples of table-format data and FAST structure data corresponding thereto; and;

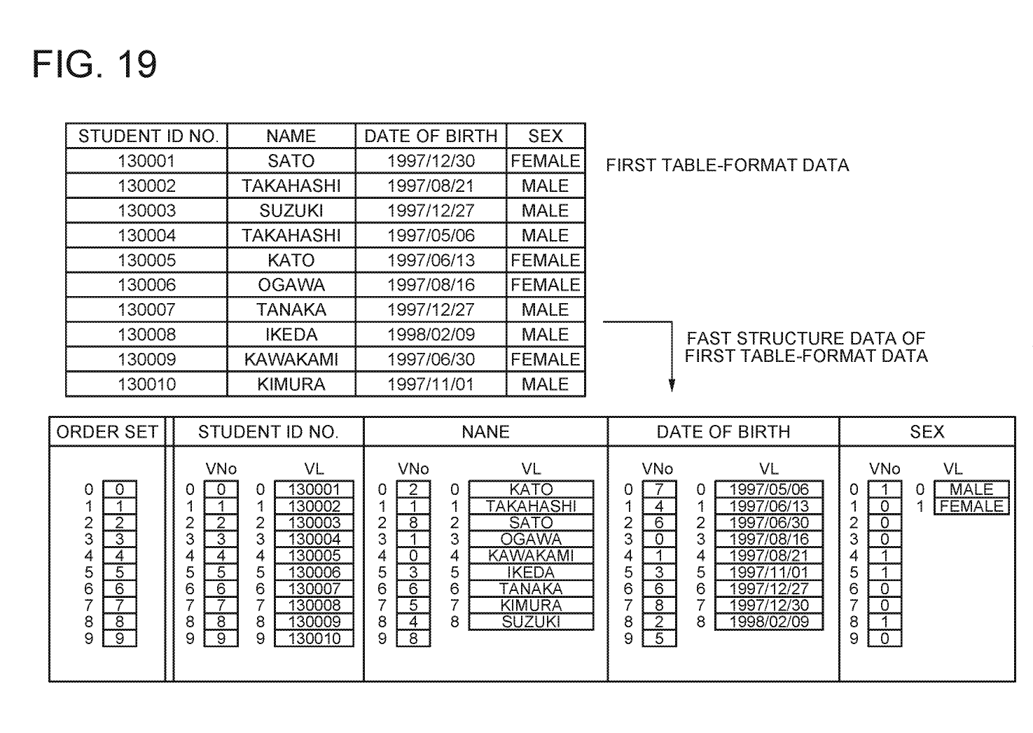

FIG. 20 is a block diagram of an information processing device for realizing a database management system.

### EXEMPLARY EMBODIMENTS

Next, embodiments of the present invention will be described in detail with reference to the drawings.

### First Exemplary Embodiment

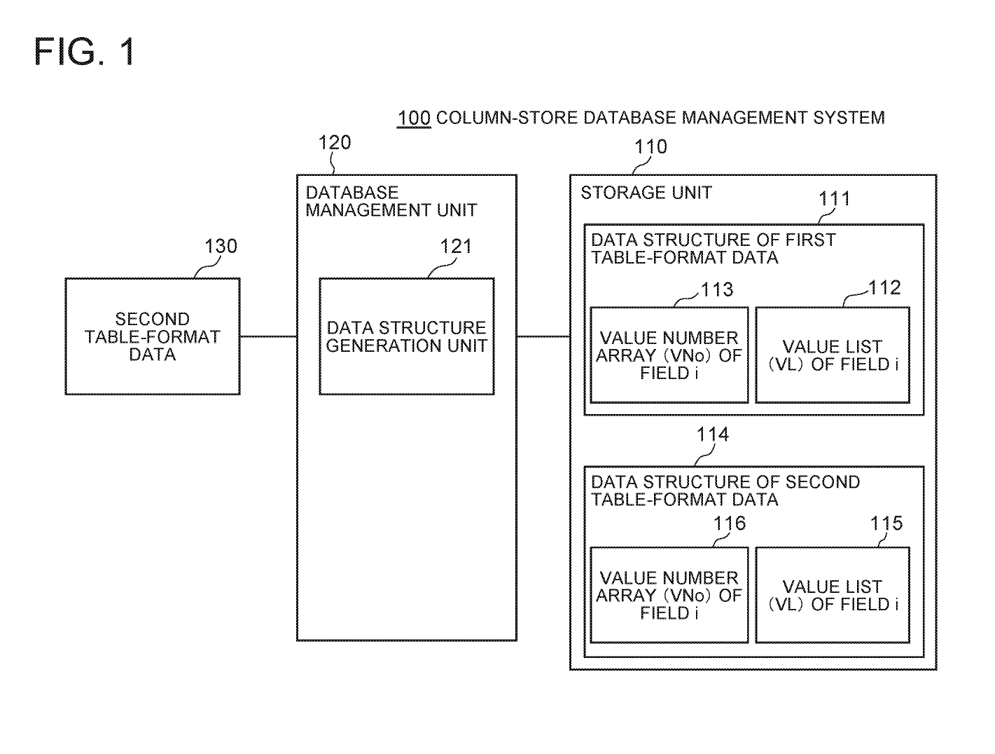

Referring to FIG. 1, a column-store database management system 100 according to a first exemplary embodiment of the present invention includes a storage unit 110, and a database management unit 120 connected with the storage unit 110.

The storage unit 110 has a function of storing a data structure corresponding to table-format data. The table-format data is expressed as arrays of records including field values related to respective fields. Meanwhile, the data structure is configured to include, for each field, a value list (hereinafter referred to as a VL) in which field values in the field are stored corresponding to field value numbers which uniquely specify the field values, and a value number array (hereinafter referred to as a VNo) in which information designating the field value numbers in the record order is stored.

The database management unit 120 includes a data structure generation unit 121 which receives table-format data and generates a data structure for storing it in the storage unit 110. The data structure generation unit 121 has a function of generating a VL according to a field of the data structure for newly storing it in the storage unit 110, with use of the VL according to the field of the data structure having been stored in the storage unit 110.

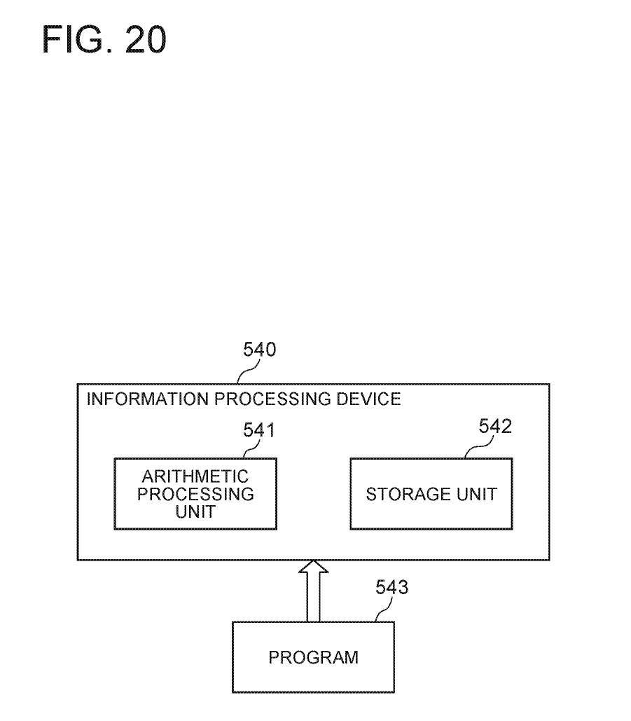

The storage unit 110 is configured of storage devices such as a memory and a hard disk of a computer, for example. Further, the database management unit 120 is configured of a microcomputer constituting an arithmetic processing unit of a computer and a program executed thereon, for example. Specifically, as shown in FIG. 20, the column-store database management system 100 is realized by an information processing device 540 including at least one arithmetic processing unit 541 such as a microprocessor, and storage units 542 such as a memory and hard disk used as the storage unit 110 or the like, and a program 543, for example. The program 543 is read from an external computer-readable recording medium to the memory at the time of startup of the information processing device 540, and controls operation of the arithmetic processing unit 541, to thereby realize the database management unit 120 on the arithmetic processing unit 541. Column-store database management systems 200, 300, 400, and 500, described below, can also be realized by the information processing device 540 and the program 543 in a similar manner.

Next, operation of the present embodiment will be described.

As an initial state, a data structure 111 of first table-format data, having been loaded before loading of second table-format data 130, is stored in the storage unit 110. The data structure 111 includes a VL 112 according to a field i, and a VNo 113 according to the field i.

When the second table-format data 130 is input, the data structure generation unit 121 of the database management unit 120 generates a data structure 114 of the second table-format data for storing it in the storage unit 110. At that time, the data structure generation unit 121 generates a VL 115 according to the field i of the data structure 114 of the second table-format data, by using the VL 112 according to the field i of the data structure 111 of the first table-format data. For example, the data structure generation unit 121 extracts, from the field i of the records of the second table-format data 130, new field values not existing in the field i of the data structure 111 of the first table-format data, and merges a result of sorting the extracted new field values with the VL 112 to thereby generate the VL 115. Further, from the generated VL 115 and the field values of the field i of the second table-format data 130, the data structure generation unit 121 generates a VNo 116 according to the field i of the data structure 114 of the second table-format data. Then, the data structure generation unit 121 stores the generated data structure 114 in the storage unit 110.

As described above, according to the present embodiment, the second table-format data 130 can be loaded at a high speed.

This is because the data structure generation unit 121 generates the VL 115 according to the field i of the data structure 114 of the second table-format data by using the VL 112 according to the field i of the data structure 111 of the first table-format data. For example, if all field values in the field i of the records of the second table-format data 130 exist in the VL 112 according to the field i of the data structure 111 of the first table-format data, the VL 112 can be used as the VL 115 as it is. While this is an extreme example, as the multiplicity between the field values in the field i of the records of the second table-format data 130 and the field values in the field i of the records of the first table-format data is higher, the number of new field values to be extracted is smaller. As such, it is possible to reduce the amount of calculation significantly, compared with the case of generating the VL 115 from scratch by using the field values in the field i of the records of the second table-format data 130.

Hereinafter, description will be given on another embodiment in which the first exemplary embodiment is described more specifically.

### Second Exemplary Embodiment

Next, a second exemplary embodiment of the present invention will be described. In the present embodiment, in a column-store database, the processing time taken for loading data having high multiplicity with past data is reduced by referring to another column or past information.

### Problem to be Solved by the Present Embodiment

As a database operating method, there is often a case where a data group is loaded in a batch such as sales data for one month or switching of a product inheritance table. In a column-store database like a FAST structure in which data is stored such that the components are decomposed for each column of the table, when such a data group is loaded in a batch, VLs (and VNos) are generated from scratch and are held. Processing to generate the VLs (and VNos) takes a longer time as the data size is larger.

The present embodiment aims to, when a new data group is loaded in a batch, reduce the time taken for generating a VL (and VNo) of the newly loaded data group, by using a VL of a column of a data group in a FAST structure, in which a large number of the data types may overlap those of the new data group. Hereinafter, a data group having been in a FAST structure is called a first data group, and a newly loaded data group is called a second data group for distinction.

### Outline of Present Embodiment

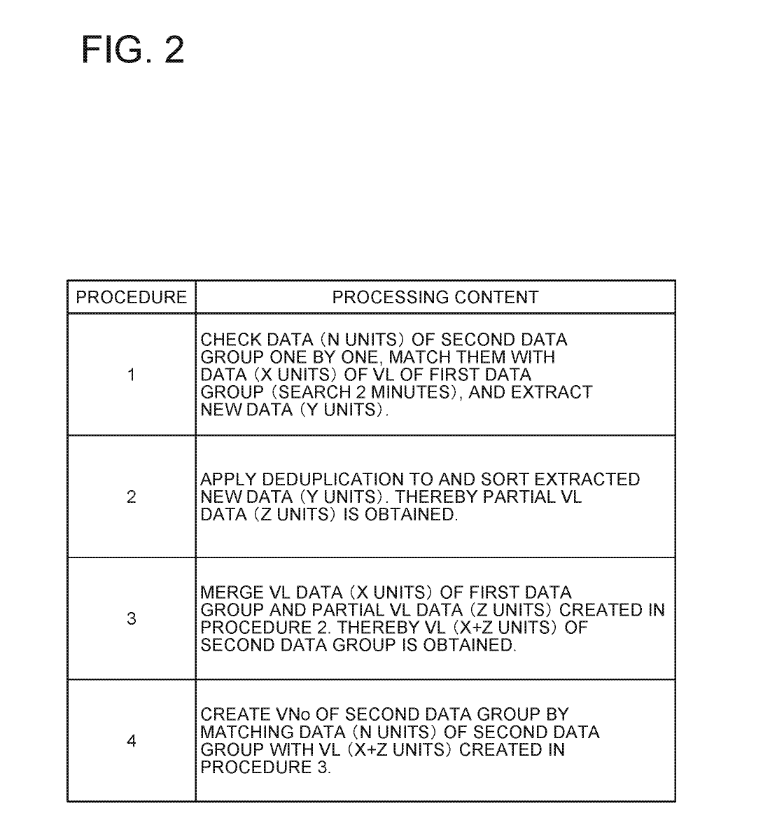

FIG. 2 shows a procedure of generating a VL and VNo of a column of the second data group by using a VL of a column of the first data group in the present embodiment. In the present embodiment, data existing in a VL (hereinafter referred to as an inheritance VL, and the column thereof is referred to as an inheritance column) of the first data group to be used has been applied with deduplication and stored in a sorted form. As such, a data group (N units) to be newly loaded is searched first, and new unique data (Y units) not existing in the data (X units) of the inheritance VL is extracted (procedure 1). Then, the extracted data (Y units) is applied with deduplication and sorted (procedure 2). Thereby, partial VL data (Z units) is obtained. Then, the partial VL data (Z units) and the inheritance VL are merged to thereby generate a VL (X+Z units) of the column of the second data group (procedure 3). As such, it is possible to reduce the processing time, compared with the method of generating a VL by applying deduplication to the data (N units) of the column of the second data group and sorting it. As the data in the inheritance VL and the second data group are in common in a larger amount (concordance rate is higher), the effect is larger. Finally, a VNo of the column of the second group data is generated while matching the data (N units) of the second data group with the VL (X+Z units) generated in procedure 3 (procedure 4).

A plurality of methods of selecting an inheritance column to be used may be considered. This will be described below.

### Configuration of the Present Embodiment

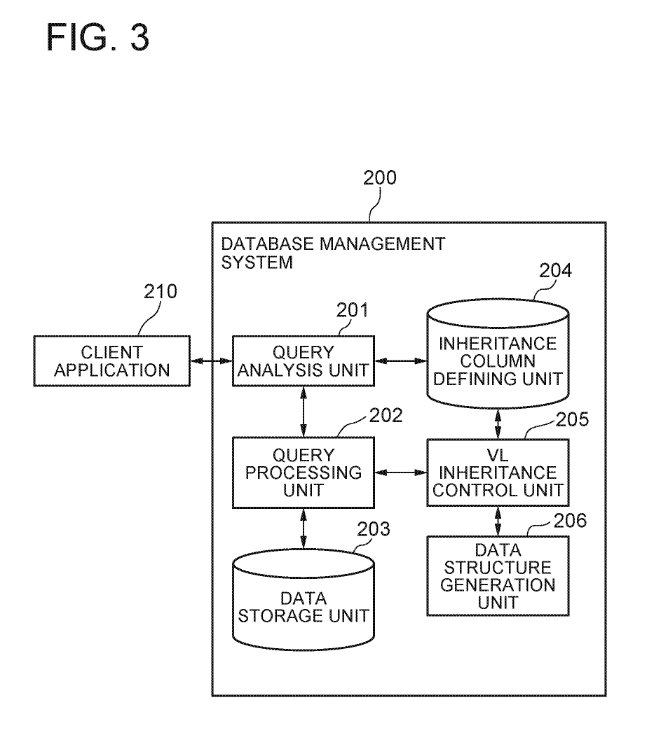

FIG. 3 is a block diagram showing the overall configuration of a database management system 200 according to the present embodiment. Referring to FIG. 3, the database management system 200 receives a query from a client application 210, analyzes and processes it, and returns the result to the client application 210. The database management system 200 includes, as main function units, a query analysis unit 201, a query processing unit 202, a data storage unit 203, an inheritance column defining unit 204, a VL inheritance control unit 205, and a data structure generation unit 206. These units 201 to 206 can be realized by the computer constituting the database management system 200 and a program operable thereon.

In the database management system 200, the query analysis unit 201 analyzes a query, and the query processing unit 202 processes the query. The query processing unit 202 reads and updates data of a FAST structure stored in the data storage unit 203 as appropriate. The inheritance column defining unit 204 holds definition information regarding which column of which table is defined as an inheritance column. The VL inheritance control unit 205 has a function of determining which column, among a plurality of columns in the load data, uses the inheritance VL of the inheritance column. The data structure generation unit 206 has a function of generating a VNo and a VL of new load data.

Next, operation of the present embodiment will be described. Hereinafter, as a case where a probability that a VL matches an existing one is high, the case of adopting a partitioning method, in which a logical table is stored while being divided into a plurality of physical tables, will be described. More specifically, the case where new section data is loaded to a table which is divided by a certain section with a partition. It should be noted that as the present invention can be carried out if the VL concordance rate between columns is high, the application thereof is not limited to partitioning.

It is often the case that long term data such as sales data is managed in one table. In that case, along with an increase in the amount of data, problems that performance of searching and tabulation processing deteriorates and that management becomes complicated occur. As a countermeasure against such a problem, there is an action of dividing a table with partitions. As an example, consideration will be given on the case of completely deleting the oldest records for one month. If such an action is not taken, it is required to search the entire sales data for the records of the target section and delete them. Meanwhile, if the above-described action has been taken, as the data for one month is set as a unit, it is only necessary to delete the unit.

In that case, as the table definition is the same, it is highly likely that the VL of the inheritance column of the prior section is effective as an inheritance VL, because there is a tendency that the types of products sold in the previous month and the types of products sold in a new month are similar, for example. However, as it may not be effective depending on the characteristics of the column, a user is required to explicitly designate a column which may be used as an inheritance column when defining the table.

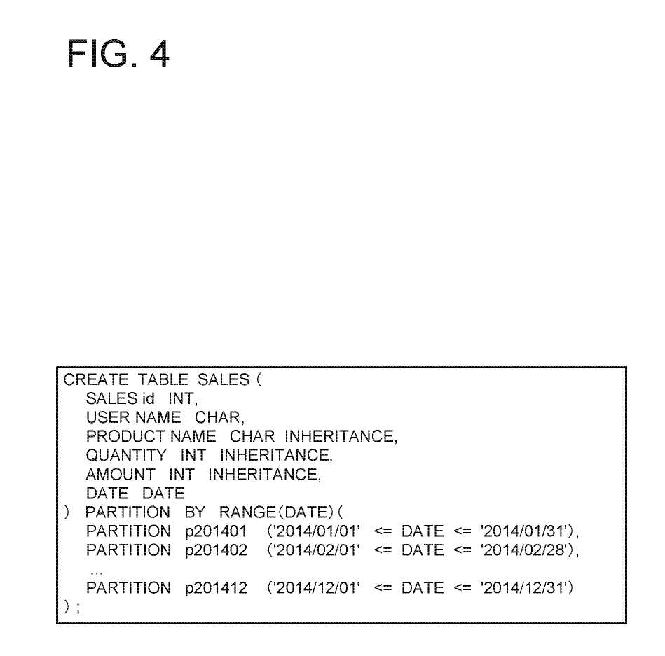

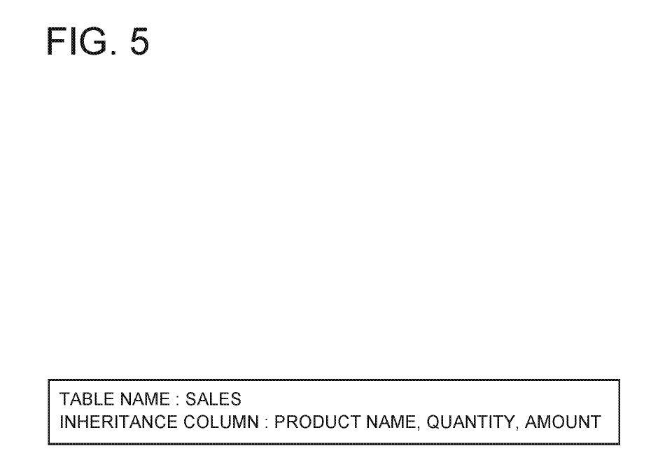

First, a query for generating a table of time-series data to be partitioned is issued from the client application 210. At that time, an inheritance column is also designated together. FIG. 4 shows an exemplary query thereof. This query shows generating a sales table, and according to values of a date column, partitioning the data by the month of 2014. The part “p2014XX” (XX represents any of 01 to 12) is a partition name. This query is a pseudo one, and an actual syntax depends on DBMS. The definition so far is a general one. In the present embodiment, a keyword “INHERITANCE” is added to the column name and the data type, in order to indicate a column serving as an inheritance column. The query analysis unit 201 reads the query, and stores information of the inheritance column and the table, as shown in FIG. 5, in the inheritance column defining unit 204. The storing method may be use of an external file, a dedicated table, or the like.

In FIG. 4, inheritance columns are designated for the columns of “product name”, “quantity”, and “amount”, while no inheritance column is designated for the other columns, namely “sales id”, “user name”, and “date”. While the grounds for excluding these columns from inheritance column designation are as described below, those grounds are exemplary given and may be changed according to data characteristics.

“Sales id”: Serial numbers in ascending order are often used. Completely different values are given to a previous section and a new section, and none of them seem to be duplicated.

“User name”: It is considered that there are a certain number of users whose purchase interval of a product is longer than a month, although depending on products or the number of users, so it is expected that the number of duplicated users is not so large between a previous section and a new section.

“Date”: As the sections are divided by the month, dates are never be duplicated between a previous section and a new section.

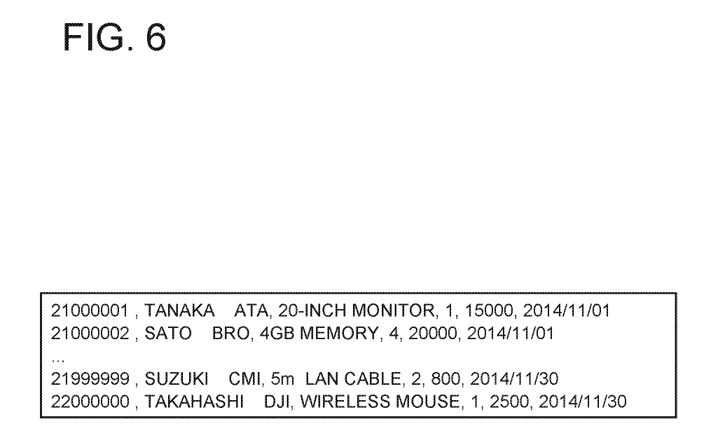

Here, consideration will be given on the case of newly loading data of one month into the sales table. Loading is performed by issuing a query specialized for loading in which an external file in CSV format or the like is designated, from the client application 210 to the database management system 200. FIG. 6 shows an exemplary content of the CSV file. This example shows data of November, 2014.

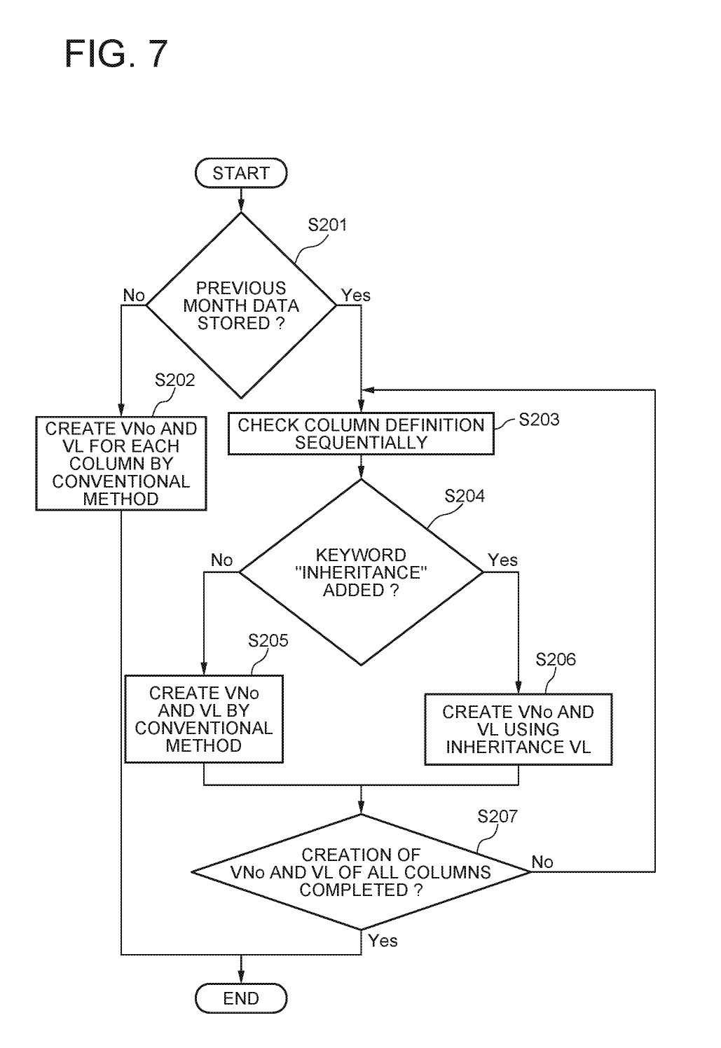

FIG. 7 is a flowchart showing a loading procedure. In the database management system 200, the query processing unit 202 determines whether or not data of a previous month exists (step S201), and if not, the data structure generation unit 206 generates a VNo and a VL of each column using a conventional method (step S202). On the other hand, if the data exists, the VL inheritance control unit 205 checks the definitions of the columns sequentially (step S203). With respect to a column to which a keyword “INHERITANCE” is not given, the data structure generation unit 206 generates a VNo and a VL of the column using a conventional method (step S205). Meanwhile, with respect to a column to which the keyword “INHERITANCE” is given, the data structure generation unit 206 generates a VNo and a VL of the column using the inheritance VL (step S206). The VL inheritance control unit 205 determines whether or not VNos and VLs of the entire columns have been generated. If not, the processing returns to step S203, and the processing same as that described above is repeated. If it has been completed, the processing of FIG. 7 ends.

Next, details of the procedures (procedures 1 to 4 in FIG. 2) of generating a VL and a VNo with use of an inheritance VL of an inheritance column at step S206 will be described.

It is assumed that the number of units of data in the inheritance VL of the “product name” column of October is 10,000 and the number of units of November data is 1,000,000, and that processing is performed on the “product column” with four CPU cores.

### Details of Procedure 1

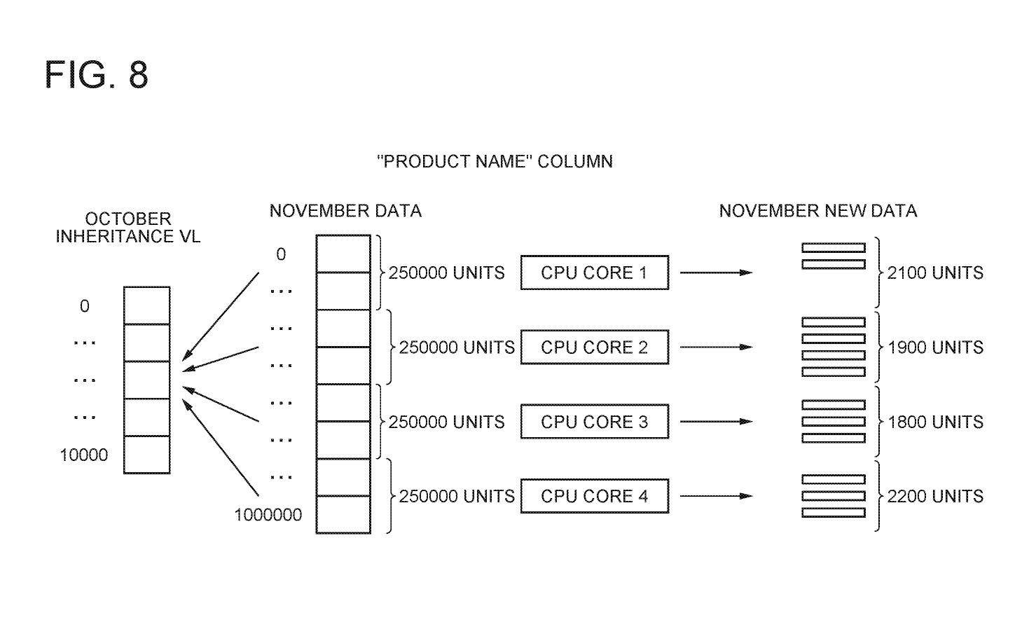

First, as shown in FIG. 8, the November data is divided into four whereby each group contains 250,000 units, and the divided units of data are allocated to the CPU cores, respectively. Each CPU core checks the 250,000 units of data from the top one by one to see whether or not it is included in the inheritance VL of October. If it is not included (that is, the product is not sold at all in October), it is extracted as new data of November. Finally, it is assumed that 8,000 units in total (total of 2,100 units extracted by the CPU core 1, 1,900 units extracted by the CPU core 2, 1,800 units extracted by the CPU core 3, and 2,200 units extracted by the CPU core 4) of new data of November are extracted (see FIG. 8).

### Details of Procedure 2

Next, the 8,000 units of data are sorted while being subjected to deduplication, whereby a new data VL (partial VL) of November is generated. This processing can be performed by eliminating duplicate data using a typical sorting method such as merge sort. Through this processing, it is assumed that the new data VL of November contains 100 units.

### Details of Procedure 3

As the partial VL generated in procedure 2 is a VL only related to the data newly appeared in November, it is merged with the 10,000 units of data (inheritance VL) which are also appeared in October. As the both VLs have been sorted, it is possible to merge them by simply comparing the two VL sequentially from the top. As a result, a VL of November of the size 10,100 (10,000+100) units is obtained.

However, it should be noted that the VL contains “data of products sold in October but not sold in November” which is unnecessary. The unnecessary data is not deleted at this timing. However, as the data is accumulated each time data of a new month is loaded, it is desirable that a user considers an operation scenario and replaces the VNo and VL periodically (once a year, for example), and deletes them at that time. Replacement of the VNo and the VL is performed using a conventional method.

### Details of Procedure 4

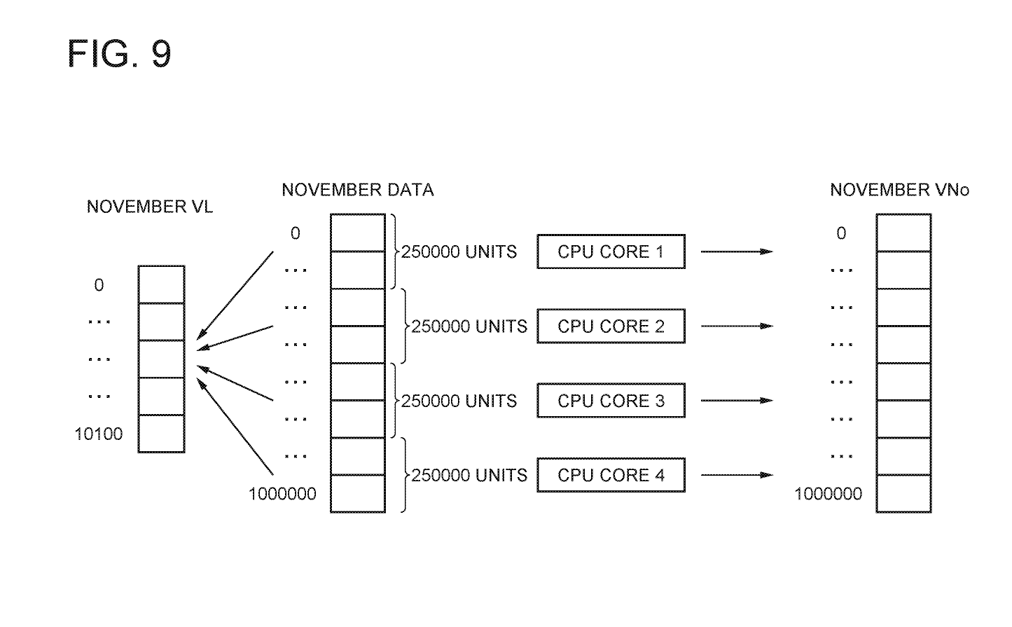

Finally, a VNo of November is generated using the VL of November. As shown in FIG. 9, the units of data of November are divided into four so that each group contains 250,000 units, and they are allocated to the CPU cores respectively. Then, one CPU core checks the 250,000 units of data from the top one by one to find out a subscript of the VL of November where it exists, and determines the found subscript to be a value of the VNo data.

### Description of Effects

As described above, according to the present embodiment, as the concordance degree between the inheritance VL and a newly generated VL is higher, the range applied with deduplication and sorting is smaller than that of a conventional method. As such, the processing time for generating the VL (and VNo) is reduced. Consequently, the processing time for loading a new data group in a batch is reduced.

### Third Exemplary Embodiment

Next, a third exemplary embodiment of the present invention will be described. A database management system of the present embodiment has a function of holding a VL data concordance rate at the time of load execution in the past as a history, and with respect to a column in which the VL data concordance rate is low so that an improvement effect is not expectable, allows a user to easily determine whether or not to cancel the inheritance column designation. Further, the database management system of the present embodiment has a function of, if the VL data concordance rate becomes smaller than a threshold, providing the user with such information or automatically cancelling the inheritance column designation.

The user performs inheritance column designation while considering whether or not the VL concordance rate between the data of a previous section and the data of a new section is high. However, as a result of continuous actual operation, there may be a case where the VL data of a previous section and that of a new section do not match a lot and the inheritance column designation is not effective. As such, in the present embodiment, VL data of a past inheritance column is stored as a history so as to allow the user to easily determine whether or not to cancel the inheritance column designation. Further, if there is a column in which the concordance rate is lower than a threshold set, such a fact may be notified to the user at the time of loading, or the inheritance column designation may be canceled automatically.

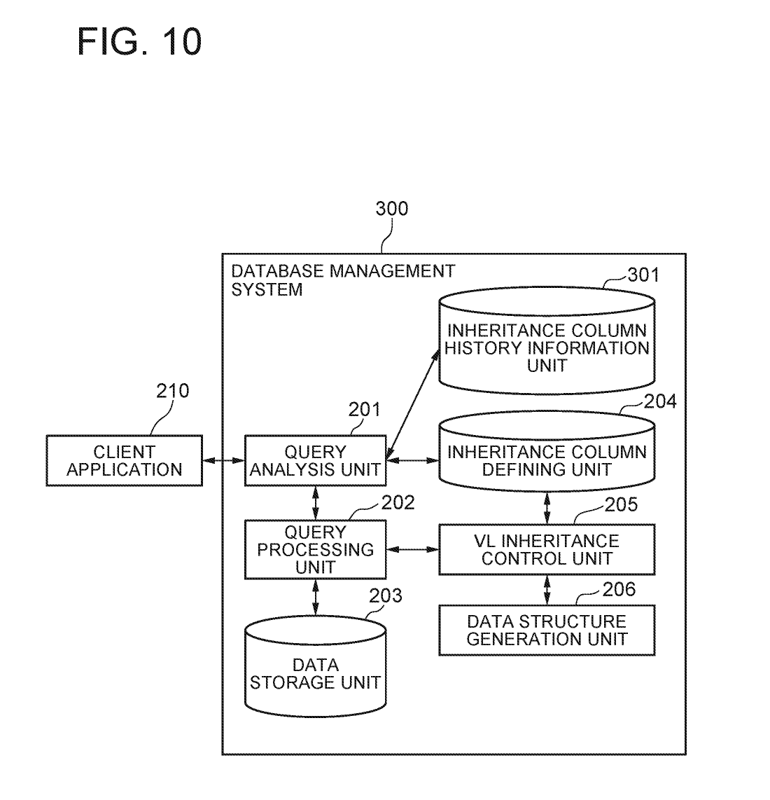

FIG. 10 is a block diagram of a database management system 300 according to the present embodiment. The database management system 300 of the present embodiment differs from the database management system 200 of the second exemplary embodiment in that the database management system 300 includes an inheritance column history information unit 301.

The inheritance column history information unit 301 has a function of storing a VL data concordance rate of an inheritance column in loading of each month. To the inheritance column history information unit 301, new data is added each time loading is performed. As the inheritance column history information unit 301, a table on the memory may be used. Another storage region such as an external file may also be used.

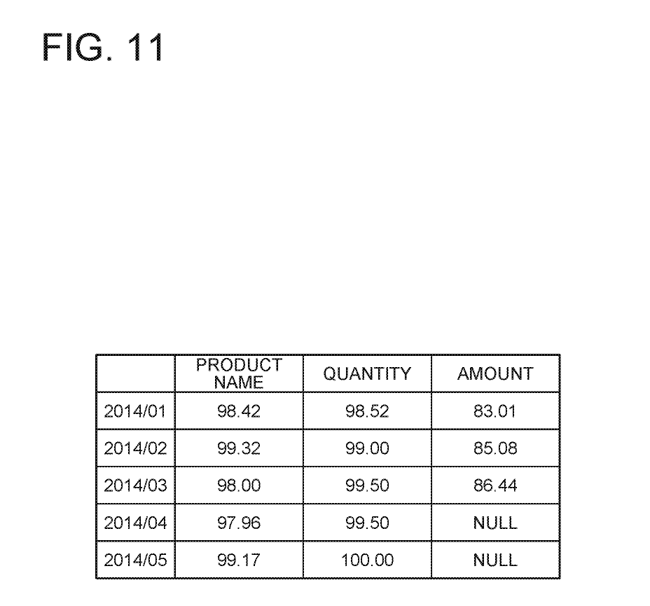

FIG. 11 shows an exemplary content of the inheritance column history information unit 301. In this example, histories of VL concordance rates in the loading of the product name, quantity, and amount, which are inheritance columns existing in the sales table, in the past five months are shown in a table format. For example, the third row of the third column of the table shows that {(the number of inheritance VL of January)/(the number of VL of February)}×100=99.00 percent of the VL matches in the quantity column, when the data of February 2014 is loaded. The VL concordance rate is generated by the data structure generation unit 206 and is stored in the inheritance column history information unit 301, for example. The inheritance column history information can be referred to freely from the client application 210.

Here, it is assumed that after loading March data, the user looks at the inheritance column history information and notices that the VL concordance rate of the amount column is lower than a threshold (95%, for example). Then, it is assumed that the user issues a query (such as ALTER TABLE) for altering the information of the inheritance column defining unit 204 to thereby delete the amount column from the inheritance columns. In that case, the data structure generation unit 206 does not use the inheritance VL when generating a VNo and a VL of the amount column after April. Further, when updating the inheritance column history information unit 301 after April, the data structure generation unit 206 puts NULL in the corresponding part of the amount column as shown in FIG. 11.

The data structure generation unit 206 may be configured such that if a concordance rate of any column becomes lower than a certain threshold (99%, for example), such a fact may be presented to a user at the time of loading in a batch. Meanwhile, if a concordance rate of any column becomes lower than a certain threshold (99%, for example), the data structure generation unit 206 may terminate the processing to generate a VL using the inheritance column for the column. Specifically, the data structure generation unit 206 may automatically cancel the inheritance column definition, and generate a VNo and a VL by a conventional method. In the case of performing it by a conventional method, the definition of the corresponding inheritance column is deleted from the inheritance column defining unit 204.

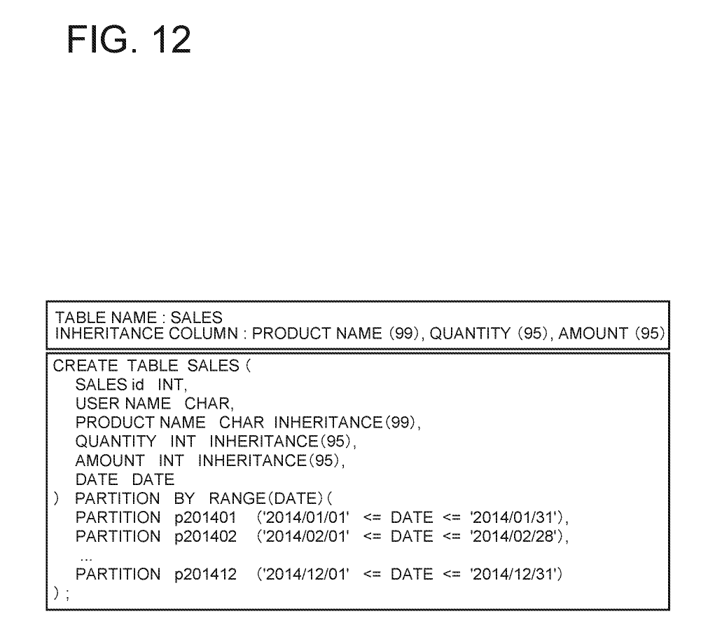

Meanwhile, the threshold may be set by a user for each column. FIG. 12 shows an example of a query for setting a threshold for each inheritance column, and an example of inheritance column definition generated based on the query. To the query and the inheritance column definition shown in FIG. 12, thresholds of 99, 95, and 95 in parentheses are added, compared with the query shown in FIG. 4 and the inheritance column definition shown in FIG. 5.

According to the present embodiment, the user is able to check the latest VL data concordance rate of each column to which an inheritance column is designated, by referring to the content of the inheritance column history information unit 301. As such, the user is able to determine which method, namely a method using an inheritance VL or a method not using an inheritance VL, he/she uses to generate a VNo or a VL of the corresponding column, based on the latest information. Then, with respect to the inheritance column in which the VL data concordance rate is low so that a high improvement effect is not expectable, by performing an operation of canceling the inheritance column designation, it is possible to select a method requiring a shorter processing time. Thereby, the overall processing time taken for batch loading can be reduced.

Further, according to the present embodiment, if a concordance rate of any column becomes lower than a certain threshold (99%, for example), it is possible to automatically terminate the processing to generate a VL using an inheritance column for the column.

### Fourth Exemplary Embodiment

Next, a fourth exemplary embodiment of the present invention will be described. A database management system according to the present embodiment may be configured to search for a column of a table in which a VL concordance rate is likely to be high at an arbitrary time, store the result, and present it to a user, to thereby allow the user to determine whether or not to designate an inheritance column, or may be configured to search for a column of a table in which the VL concordance rate exceeds a threshold at an arbitrary time, store the detection result, and present it to the user, to thereby allow the user to determine whether or not to designate an inheritance column. Otherwise, the database management system may be configured to search for a column of a table in which the VL concordance rate exceeds a threshold at an arbitrary time, and automatically designate it to be an inheritance column.

Even for a column not designated to be an inheritance column, there may be another column which can be used as an inheritance VL. For example, although a user name column in a sales table is excluded as an inheritance column in the second exemplary embodiment, as another table other than a physical table constituting a logical table, a master table of a user name should exist in most cases, and all users should be included in the user name column thereof. As such, if the VL of the user name column of the master table is used as an inheritance VL, the VL concordance rate will be 100%.

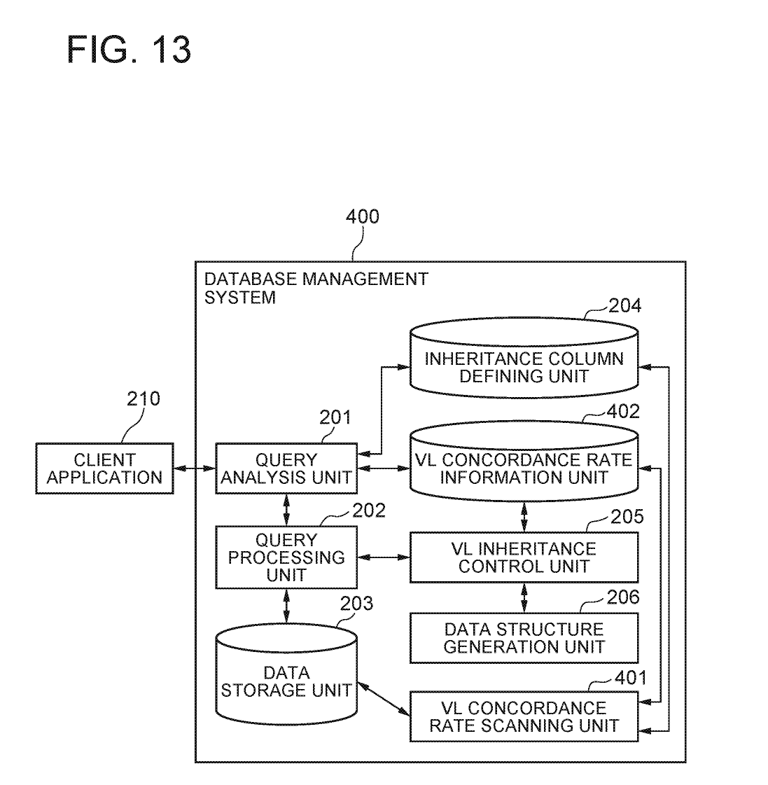

FIG. 13 is a block diagram of a database management system 400 according to the present embodiment. The database management system 400 of the present embodiment differs from the database management system 200 of the second exemplary embodiment in that the database management system 400 includes a VL concordance rate scanning unit 401 and a VL concordance rate information unit 402.

The VL concordance rate scanning unit 401 has a function of automatically searching for a column of another table which is likely to have a high VL concordance rate with a column of a table that the table name is defined in the inheritance column defining unit 204 (hereinafter referred to as a target column, in the example of FIG. 5, a column of a sales table), periodically (during nighttime when a system load is low, for example). For example, the VL concordance rate scanning unit 401 searches for a column set fully satisfying the conditions of the same schema, the same column name, and the same data type as those of the target column, compares the VL of each column with the VL of the target column, and calculates a VL concordance rate, similar to the third exemplary embodiment. The VL concordance rate scanning unit 401 writes the calculated result into the VL concordance rate information unit 402. The VL concordance rate information unit 402 may be a table on the memory. Another storage region such as an external file may also be used.

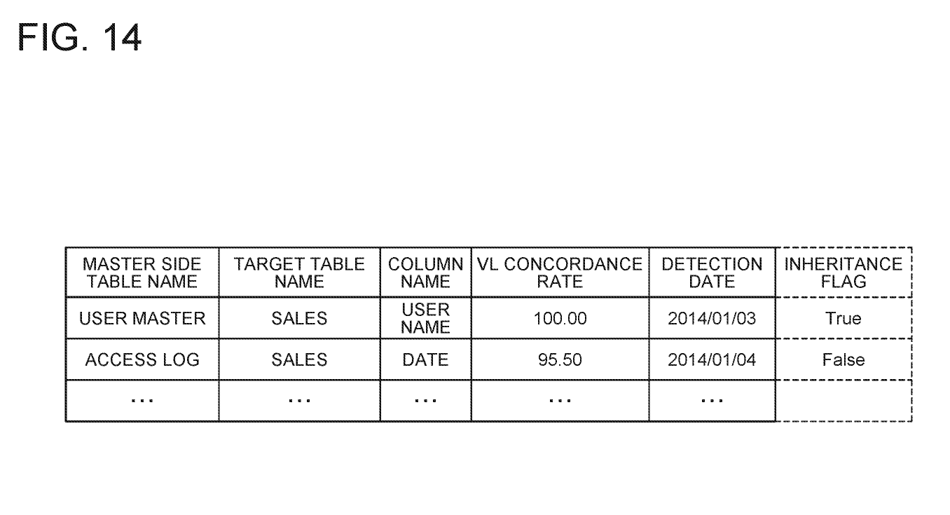

FIG. 14 shows an exemplary content of the VL concordance rate information unit 402. The VL concordance rate information unit 402 of this example stores a plurality of records, and each record has fields such as a master side table name, a target table name, a column name, a VL concordance rate, and detection date. For example, an entry on the second row shows that it is detected on Jan. 3, 2014 that the VL concordance rate of the user name in the sales table with respect to the user name in the user master table is 100%. The VL concordance rate information unit 402 is able to be referred to from the client application 210 freely. If a user looks at this information and finds that the concordance rate of user names is high, when the user performs data loading of the sales table next time and after, the user may perform loading using the VL of the sales column in the user master table as an inheritance VL for generating a VNo and a VL of a user name column.

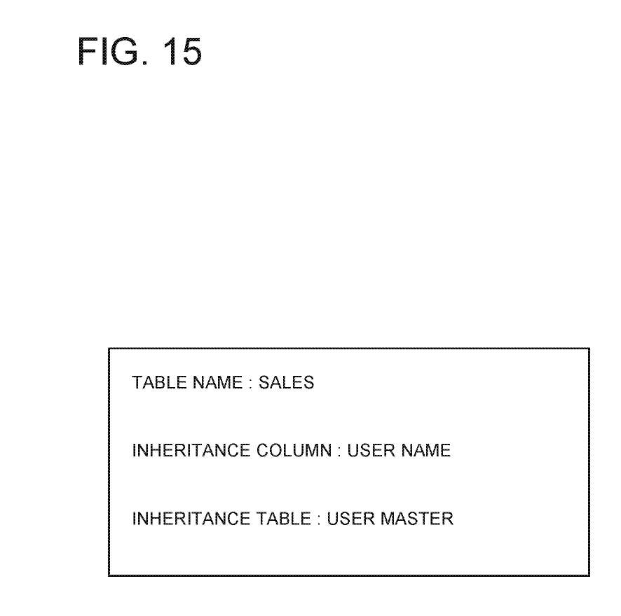

FIG. 15 shows an exemplary content of the inheritance column defining unit 204 of the present embodiment. In order to use a column in another table as an inheritance VL, an inheritance-side table name and a column name are defined. In order to generate such an inheritance column definition, a method of designating an inheritance-side table name and a column made in the query in which batch loading is performed, may be considered, for example.

The VL concordance rate scanning unit 401 may be configured to, if the detected VL concordance rate exceeds a certain threshold (99%, for example), present the fact to a user at the time of batch loading, or automatically rewrite the content of the inheritance column defining unit 204 to that shown in FIG. 15. Otherwise, the VL concordance rate information unit 402 may have the function of the inheritance column defining unit 204. For example, an inheritance flag field (initial value is “False”), as shown by a broken line in FIG. 14, is added to the VL concordance rate information unit 402, and if a detected VL concordance rate exceeds a predetermined threshold (99%, for example), the VL concordance rate scanning unit 401 changes the value of the inheritance flag from False to True. Regarding the column of the sale table described in the entry in which the value of the inheritance flag is changed to True in the VL concordance rate information unit 402, the VL inheritance control unit 205 controls such that the column in the table described in the master side table name of such an entry is used as an inheritance VL.

As described above, according to the present embodiment, as another table having a column in which the VL concordance rate with the column of the target table to be loaded is high is searched and is presented to a user, the user is able to find an inheritance VL from a wide range of table groups. Consequently, the entire processing time for batch loading can be reduced.

Further, according to the present embodiment, the database management system can be configured to detect another table having a column in which the VL concordance rate with the column of a target table to be loaded is high, and automatically use it as an inheritance VL. Consequently, the entire processing time for batch loading can be reduced.

### Fifth Exemplary Embodiment

Next, a fifth exemplary embodiment of the present invention will be described. In the fifth exemplary embodiment of the present embodiment, if there is a column which includes all types of data of a column to be newly loaded in another table, the VL of such a column is used as a VL of the column to be newly loaded to thereby substantially eliminate processing to generate a new VL. Hereinafter, description will be given with use of a product name column in the product table described in the second exemplary embodiment as an example.

In the second exemplary embodiment, a product name column is defined as an inheritance column, and procedures 1 to 4 of FIG. 2 are performed to thereby generate a VNo and a VL of November. Among the four procedures, procedures 1 to 3 are processing to generate a VL of November. Here, considering the characteristics of the column, there is a product name column of a product master table which includes all product names, generally, besides the sales table. By using the VL of the product name column of the product master table directly as a VL of the product name column of November, processing to generate a VNo and a VL is completed by starting the processing from procedure 4, while omitting the processing of procedures 1 to 3. Hereinafter, a product name column of the product master table is called a master column. In that case, it is necessary that the product name column of the product master table should become the latest one from the time of loading the sales table in October until the time of newly loading in November.

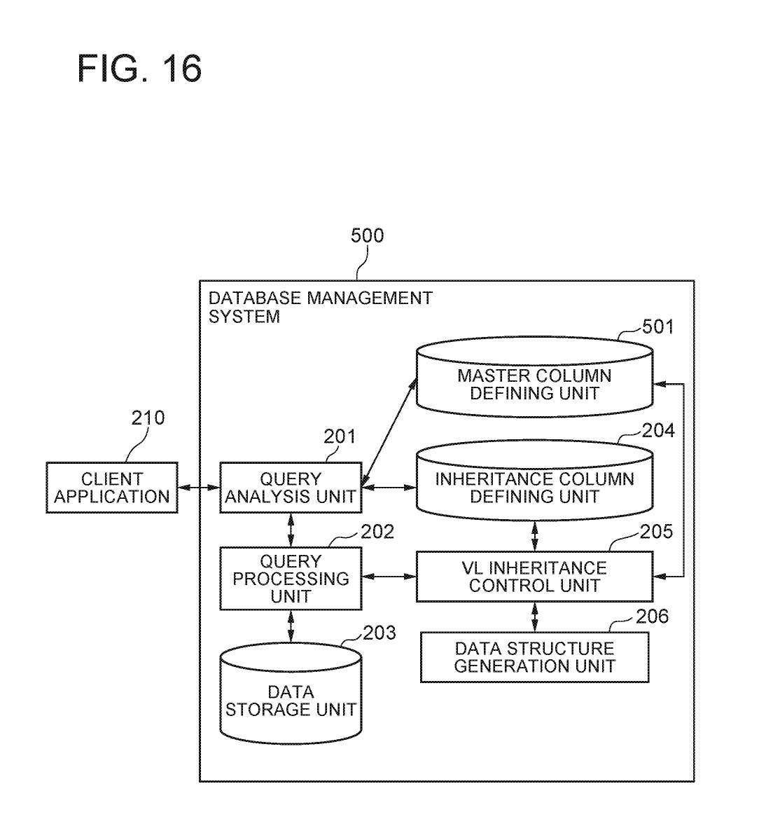

FIG. 16 is a block diagram of a database management system 500 according to the present embodiment. The database management system 500 of the present embodiment differs from the database management system 200 of the second exemplary embodiment in that the database management system 500 includes a master column defining unit 501.

The master column defining unit 501 stores information defining which column of which table is used as a master column.

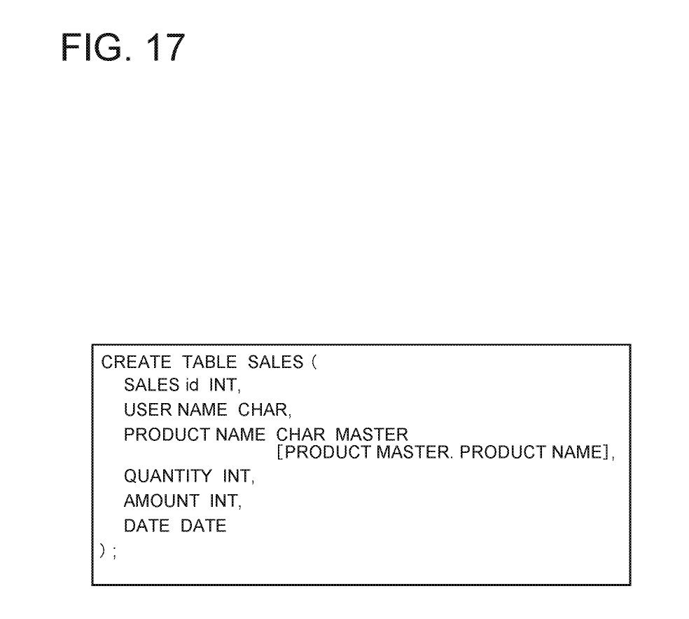

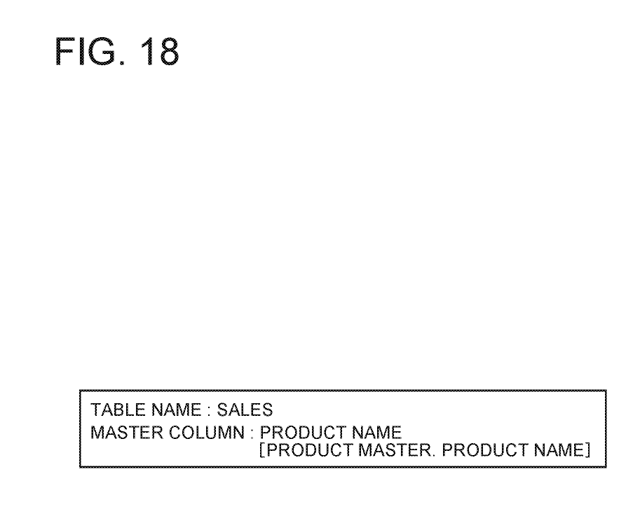

FIG. 17 shows an exemplary definition of a sales table. As shown in FIG. 17, a description “MASTER [product master. product name]” is provided after the definition of the product name column. This description defines that the product name column of the product master table is used as a master column and that the VL thereof is used as a VL of the product name column of the sales table. The query analysis unit 201 analyzes the definition of the sales table, and writes the master column definition as shown in FIG. 18 into the master column defining unit 501.

The procedure is as follows: new product data is loaded to the product master table and the VL of the master column is updated, before the data of the sales table is loaded, and then, November sales data is loaded in a batch.

When generating a VNo and a VL of the product name column, procedure 4 is performed using the VL of the product name column of the product master table, while omitting procedures 1 to 3, to thereby generate a VNo.

Compared with the second exemplary embodiment, processing to generate a VNo and a VL of the column is performed faster, because the processing of procedures 1 to 3 is omitted. This does not mean that the processing of procedures 1 to 3 can be omitted with respect to all columns.

First, regarding unspecific numerical columns such as quantity and amount, as there is almost no column serving as a master, the above-described method cannot be used.

Second, if the size of the master VL is largely deviated from the number of types of data to be newly loaded, a performance problem is caused. For example, it is assumed that the number of types of the product names in the product master table is 100,000, while the number of types of the products sold in November is 5,000. If the method of the second exemplary embodiment is used rather than the method of the present embodiment, the VL of the November product name column contains almost 5000 units of data, while it contains 100,000 units of data if the method of the present embodiment is used. The 100,000 units largely include data of the products which were not sold in November. As such, the number of units of VL data to be scanned becomes wastefully large when performing search processing, for example, which causes deterioration in the performance.

Finally, there is a problem of data consistency. Data transmitted from the client application 210 is not always correct. Unnecessary wasteful data may be mixed, or necessary data may be insufficient sometimes. Considering such a problem, it is also considered to perform procedures 1 to 3 intentionally. For example, consideration will be given on the case where data of a new product, which should be loaded, is missed when new product data is loaded to the product master, and further, one or more pieces of the new product are sold in November. In the case of performing procedures 1 to 3, at the time of performing processing to extract new data of November, it is possible to extract the missed new product data and put it in the November VL. However, in the method of the present embodiment, as the new product data is not included in the VL at the time of generating a VNo, a VNo cannot be generated, whereby data inconsistency occurs. In that case, the processing using the method of the present embodiment is terminated, and the processing is performed again from the beginning using the method of the second exemplary embodiment.

As described above, according to the present embodiment, as the processing of extracting new VL data in procedures 1 to 3 can be omitted, the processing time for generating a VNo and a VL of a column can be reduced accordingly.

While the present invention has been described with reference to some exemplary embodiments described above, the present invention is not limited to the above-described embodiments, and various additions and changes can be made thereto.

### INDUSTRIAL APPLICABILITY

The present invention is applicable to a column-store database management system using a FAST structure. In particular, the present invention is effective in the case where, at the time of loading a set of data in a batch, the allowable processing time is determined (the case where the maintenance time is determined from what time to what time, for example) and loading will not be completed within the allowable time. This means that by using the present invention, it is possible to reduce the loading time so as to complete it within the allowable time.

1. A column-store database management system comprising:
a storage unit that stores a data structure corresponding to table-format data expressed as arrays of records including field values relating to each field, the data structure including, for each field, a value list and a value number array, the value list being configured such that field values in the field are stored corresponding to field value numbers uniquely specifying the field values, the value number array being configured such that information designating the field value numbers in a record order is stored; and
a database management unit connected with the storage unit; wherein
the storage unit is configured to store a first data structure that corresponds to first table-format data and includes the value list and the value number array according to a first field,
the database management unit includes a data structure generation unit that generates a second data structure for storing in the storage unit from second table-format data input, and
the data structure generation unit is configured to generate the value list according to the first field of the second data structure with use of the value list according to the first field of the first data structure.

2. The column-store database management system, according to claim 1, wherein
the database management unit extracts a new field value not existing in the first field of the first data structure, from the first field of records of the second table-format data, and
in order to generate the value list according to the first field of the second data structure, the database management unit is configured to merge a sorting result of the new field values and the value list according to the first field of the first data structure.

3. The column-store database management system, according to claim 1, wherein
the database management unit includes an inheritance control unit that controls the data structure generation unit, based on an inheritance column definition that defines, for each field of records of the second table-format data, whether or not to generate the value list according to the field by using the value list according to a corresponding field of the first table-format data.

4. The column-store database management system, according to claim 1, wherein
the database management unit includes an inheritance column history information unit that is referable from a user, and
the data structure generation unit is configured to calculate a concordance degree between the value list according to the first field of the second data structure and the value list according to the first field of the first data structure, and store the calculated concordance degree in the inheritance column history information unit.

5. The column-store database management system, according to claim 1, wherein
the database management unit includes a concordance rate information unit that is referable from a user, and a concordance rate detection unit, the concordance rate detection unit being configured to detect, from a data structure of a table-format data other than the first data structure, a field in which a concordance rate with a field value of a field other than the first field of the second data structure is not lower than a threshold, and store the detection result in the concordance rate information unit.

6. The column-store database management system, according to claim 1, wherein
the data structure generation unit is configured such that if the value list according to the first field of the first data structure is a value list according to a master table having all field values existing in the first field of records of the second table-format data, the data structure generation unit uses the value list according to the first field of the first data structure itself as the value list according to the first field of the second data structure.

7. The column-store database management system, according to claim 1, wherein
the data structure generation unit is configured to generate the value number array according to the first field of the second data structure, from the value list according to the first field of the second data structure and the field value of the first field of the second table-format data.

8. A data loading method in a column-store database management system including a storage unit that stores a data structure corresponding to table-format data expressed as arrays of records including field values relating to each field, the data structure including, for each field, a value list and a value number array, the value list being configured such that field values in the field are stored corresponding to field value numbers uniquely specifying the field values, the value number array being configured such that information designating the field value numbers in a record order is stored; and a database management unit connected with the storage unit; the method comprising:
by the storage unit, storing a first data structure that corresponds to first table-format data and includes the value list and the value number array according to a first field;
by the database management unit, generating a second data structure for storing in the storage unit from second table-format data input, wherein
in the generating the second data structure, the database management unit generates the value list according to the first field of the second data structure with use of the value list according to the first field of the first data structure.

9. The data loading method, according to claim 8, wherein
the database management unit extracts a new field value not existing in the first field of the first data structure, from the first field of records of the second table-format data, and
in order to generate the value list according to the first field of the second data structure, the database management unit merges a sorting result of the new field values and the value list according to the first field of the first data structure.

10. The data loading method, according to claim 8, wherein
the database management unit generates the second data structure based on an inheritance column definition that defines, for each field of records of the second table-format data, whether or not to generate the value list according to the field by using the value list according to a corresponding field of the first table-format data.

11. The data loading method, according to claim 8, wherein
the database management unit calculates a concordance degree between the value list according to the first field of the second data structure and the value list according to the first field of the first data structure.

12. The data loading method, according to claim 8, wherein
the database management unit detects, from a data structure of a table-format data other than the first data structure, a field in which a concordance rate with a field value of a field other than the first field of the second data structure is not lower than a threshold.

13. The data loading method, according to claim 8, wherein
if the value list according to the first field of the first data structure is a value list according to a master table having all field values existing in the first field of records of the second table-format data, the database management unit uses the value list according to the first field of the first data structure itself as the value list according to the first field of the second data structure.

14. The data loading method, according to claim 8, wherein
the database management unit generates the value number array according to the first field of the second data structure, from the value list according to the first field of the second data structure and the field value of the first field of the second table-format data.

15. A non-transitory computer readable medium storing a program comprising instructions for causing a computer to function as, the computer constituting a database management unit in a column-store data management system, the column-store data management system including a storage unit and the database management unit connected with the storage unit, the storage unit storing a data structure corresponding to table-format data expressed as arrays of records including field values relating to each field, the data structure including, for each field, a value list and a value number array, the value list being configured such that field values in the field are stored corresponding to field value numbers uniquely specifying the field values, the value number array being configured such that information designating the field value numbers in a record order is stored, the storage unit storing a first data structure corresponding to the first table-format data and including the value list and the value number array according to a first field:
a data structure generation unit that generates a second data structure for storing in the storage unit from second table-format data input, and in the generating, generates the value list according to the first field of the second data structure with use of the value list according to the first field of the first data structure.
